(19) United States
(12) Patent Application Publication
(10) Pub. No.: US 2024/0298840 A1
(43) Pub. Date: Sep. 12, 2024

(54) AUTOMATED POUROVER COFFEE BREWING MACHINE WITH CONTROLLED SPIRAL OR SPIRAL-LIKE WATER DISPENSING USING A DUAL-DISK SYSTEM

(71) Applicant: Julio Claude Rizk, New York, NY (US)

(72) Inventor: Julio Claude Rizk, New York, NY (US)

(21) Appl. No.: 18/597,272

(22) Filed: Mar. 6, 2024

Related U.S. Application Data
(60) Provisional application No. 63/489,729, filed on Mar. 10, 2023.

(51) Int. Cl. A47J 31/46; A23F 5/26; A47J 31/02; A47J 31/10; A47J 31/52; A47J 31/56

(52) U.S. Cl. CPC A47J 31/468; A23F 5/262; A47J 31/02; A47J 31/10; A47J 31/461; A47J 31/521; A47J 31/5253; A47J 31/56

(57) ABSTRACT

A system and mechanism for an automated pour-over coffee machine is disclosed. In some embodiments, a disk mechanism for brewing pour-over coffee is utilized. The disk mechanism may include a first disk and a second disk that are rotatably coupled. The disk mechanism may be configured to couple to a nozzle that dispenses water onto coffee grounds and to move the nozzle along a desired pattern for pouring water.

### CROSS-REFERENCE TO RELATED APPLICATIONS

This application claims the benefit of U.S. Provisional Application No. 63/489,729 filed Mar. 10, 2023, which is hereby incorporated herein by reference in its entirety.

### BACKGROUND

Coffee brewing has evolved significantly due to increased access to high quality coffee beans, called Specialty Coffee, which require a more methodical and scientific brewing techniques to extract the best flavors. Coffee brewing falls within three main categories, immersion, pour-over or drip, and espresso.

The pour-over method to brew coffee is typically a manual process and can require an individual to spend about 4 to about 8 minutes preparing and brewing a cup of coffee. In both commercial and residential settings, the pour-over method is nearly always performed manually. Ground coffee beans are generally placed in a paper filter or perforated stainless steel cone held in a glass, ceramic or plastic filter holder, and the user gradually adds hot water evenly to the entire surface area of the coffee grounds to evenly expose the coffee to the water and to achieve even extraction. Water dispensing can take place in multiple water dispensing stints that each add a little bit more water to the ground coffee. During water dispensing, a user needs to maintain consistent water temperature and be precise about amount of water dispensed in each stint.

Controlling water temperature, water flow, and/or brewing time affects the quality of the coffee extraction in pour-over brewing. For example, these factors may need to be precisely controlled to brew high quality coffee that utilizes a full, even, uniform, and optimized coffee extraction. Many pour-over coffee machines only drip water onto coffee grounds through a showerhead or similar device. Dripping water in this way typically does not allow the same control as required to make high quality coffee.

Therefore, there remains a need for improved pour-over coffee machines.

### SUMMARY

In one aspect, an apparatus for brewing coffee can comprise a nozzle, a disk assembly, and a drive system. The nozzle is generally configured to dispense a fluid. The disk assembly may comprise a first disk and a second disk. The first disk may define an opening that is configured to receive the nozzle, and the opening may extend along the first disk in a radial direction. The second disk may define a guide opening that is configured to receive the nozzle, and the guide opening may extend in a circumferential direction along the second disk. The first disk and the second disk are typically rotatably coupled together. The drive system may be mechanically linked to the first disk and configured to rotate the first disk relative to the second disk. As the first disk rotates, the first disk may move the nozzle. The opening on the first disk may allow the nozzle to move in a radial direction as the first disk rotates. The guide opening on the second disk may direct the nozzle at least partially along a circumferential direction as the first disk moves the nozzle.

In one embodiment, the guide opening on the second disk is spiral shaped. In such embodiment, the disk assembly may move the nozzle in a spiral-shaped path by moving the nozzle along the spiral-shaped guide opening. The spiral shape may be similar to the pattern used to manually pour water onto coffee grounds in typical manual pour-over coffee brewing. The spiral shape may further ensure that water is evenly dispersed onto the coffee grounds and that the coffee grounds are evenly saturated during the pour.

In certain embodiments, the disk assembly may be configured to limit or fully prevent movement of the nozzle in a longitudinal direction. By limiting the longitudinal movement, the movement along the guide opening can be reliable and smooth. In another embodiment, the first disk may define a rail around the opening. The nozzle may include a ring that extends in a radial direction around the nozzle. The rail may receive the nozzle ring when the nozzle is positioned within the opening on the first disk. The rail may facilitate the movement of the nozzle along the radial opening of the first disk and may allow the nozzle to rotate within the opening. In yet another aspect, the first disk and second disk may be made of a low-friction material.

In preferred aspects, a pour-over apparatus may be incorporated into a coffee machine or another system for brewing coffee. Such a system may comprise the nozzle, the disk assembly, a drive system, a body, and a receptacle. A disk assembly may generally move the nozzle around a spiral path, and the drive system can rotate the disk assembly. A body may be configured to support the nozzle, disk assembly, and motor above the receptacle. A receptacle may generally be configured to receive water that the nozzle dispenses. A body can define a central opening that is configured to receive the receptacle. When a receptacle is positioned in the central opening under the disk assembly and nozzle, a disk assembly may move a nozzle in a spiral pattern to dispense water in to the receptacle. A spiral pattern may be similar to a desired manual pouring pattern used in traditional pour-over coffee brewing.

A body can be shaped in a variety of ways. In one example, the central opening of a body may extend from a first side of the body to a second side of the body such that when the receptacle is positioned within the central opening, the dripper may be visible from the first side and/or from the second side. By extending the central opening fully through the body, an operator of the coffee brewing system and a customer may both be able to see and interact with the coffee brewing system, specifically with the receptacle.

In preferred embodiments, the coffee brewing system disclosed herein may include a control unit. A control unit may be configured to operate or control one or more components of the coffee brewing system. Specifically, a control unit may be configured to control the speed and direction of a motor in the drive system. For example, in one embodiment, a control unit may determine when the nozzle is at an end of the guide opening, and/or the control unit can adjust the movement of the motor. In another embodiment, a coffee brewing system may further include a pump that is fluidly connected to the nozzle using a hose. A pump may generally be configured to move fluid to a nozzle through the hose. A control unit may be configured to control the time and speed at which a pump operates. For example, in one embodiment, a hose may be connected to a nozzle using a swivel fitting so as to allow a nozzle to rotate without tangling the hose. In yet another embodiment, a pump can be connected to a multi-way valve. In some embodiments a multi-way valve may be a two-way valve or may be a three-way valve. In one aspect, the multi-way valve may connect a nozzle to a pump. Or, for example, in another embodiment a multi-way valve may connect a pump to another component in the system, such as a water tank or a drain. A control unit may be configured to operate a pump and/or the multi-way valve to move fluid to a nozzle during a specified pour time, and/or after a specified pour time, a control unit may operate the pump and the multi-way valve to allow fluid to move to other components and/or away from the nozzle.

In another aspect, a coffee brewing system may further include a heater that can heat fluid before and/or while a pump moves fluid to a nozzle. By heating in a controlled manner, a heater can allow the coffee brewing system to brew coffee with water at a desired temperature. Such a coffee brewing system may further include one or more temperature sensors that are configured to measure the temperature of a fluid. A control unit may control a heater based on measured temperatures of a fluid and control the temperature to which the heater heats a fluid.

The system may further include a control interface that allows a user to provide inputs to the control unit, such as buttons or a touch screen. In one embodiment, a control unit may communicatively couple to an external device and can receive instructions from the external device. For example, in certain embodiments, a user can provide inputs to a control unit through a touchscreen or other input device on the external device. A control unit may operate one or more components based on instructions received from an external device. For example, in one embodiment, an external device may be a mobile device, and a mobile device may allow a user to enter instructions through an application installed on the mobile device. For example, a user may provide instructions using an application on a mobile phone or smart phone. In another aspect, an external device may allow a user to create and store a custom set of commands, such as a custom brewing process or coffee recipe.

Additional embodiments of the invention, as well as features and advantages thereof, will be apparent from the descriptions herein.

### BRIEF DESCRIPTION OF THE DRAWINGS

FIG. 1A is a top perspective view of a disk mechanism and a nozzle according to one embodiment of the present disclosure for use in a pour-over coffee machine.

FIG. 1B is a bottom perspective view of a disk mechanism and a nozzle.

FIG. 1C is a perspective view of a disk mechanism coupled to a drive system.

FIG. 2A is a side elevation view of a first disk.

FIG. 2B is a top plan view of a first disk.

FIG. 2C is a top perspective view of a first disk.

FIG. 2D is a bottom perspective view of a first disk.

FIG. 3A is a side elevation view of a second disk.

FIG. 3B is a top plan view of a second disk.

FIG. 3C is a top perspective view of a second disk.

FIG. 3D is a bottom perspective view of a second disk.

FIG. 4A is a perspective view a nozzle.

FIG. 4B is a perspective view of a nozzle and a second disk.

FIG. 4C is a perspective view of a nozzle and a disk mechanism. in a partially disassembled arrangement.

FIG. 4D is a perspective view of a nozzle and a disk mechanism in an assembled arrangement.

FIG. 5A is a bottom view of a nozzle and a disk mechanism at a first position during operation.

FIG. 5B is a bottom view a nozzle and a disk mechanism at a second position during operation of a pour-over coffee machine.

FIG. 5C is a bottom view of a nozzle and a disk mechanism at a third position during operation.

FIG. 5D is a bottom view a nozzle and a disk mechanism at a fourth position during operation.

FIG. 6A is a front elevation view of a coffee machine.

FIG. 6B is a perspective view of a coffee machine.

FIG. 7 is a diagram of a main user interface that may allow a user to control the operation a coffee machine.

FIG. 8 is a diagram of a first brew page that may be accessed from a main user interface.

FIG. 8A is a diagram of a first brew page during a brew operation.

FIG. 9 is a diagram of a second brew page.

FIG. 9A is a diagram of a second brew page during a rinse operation.

FIG. 9B is a diagram of a second brew page after a rinse operation.

FIG. 9C is a diagram of a second brew page during a brew operation.

FIG. 9D is a diagram of a brew detail page that can be accessed from a second brew page.

FIG. 9E is a diagram of an alternative embodiment of a brew detail page.

FIG. 10A is a diagram of a recipe page.

FIG. 10B is a diagram of a roaster selection page.

FIG. 10C is a diagram of a roaster recipe selection page.

FIG. 10D is a diagram of a roaster recipe detail page.

FIG. 10E is a diagram of another embodiment of a recipe page.

FIG. 10F is a diagram of a user recipe selection page.

FIG. 10G is a diagram of a user recipe detail page.

FIG. 11A is a diagram of a customization page.

FIG. 11B is a diagram of a stint selection page.

FIG. 11C is a diagram of a recipe information page.

FIG. 11D is a diagram of a notes page.

FIG. 11E is a diagram of another embodiment of a customization page.

FIG. 12A is a diagram of a settings page.

FIG. 12B is a diagram of an account page.

### DETAILED DESCRIPTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications, and such further applications of the principles of the invention as described herein being contemplated as would normally occur to one skilled in the art to which the invention relates.

Most automatic brewing devices today utilize a showerhead to dispense water onto a coffee bed such as invention under patents U.S. Pat. No. 10,687,652-B1, US-2020397178-A1. Furthermore, these devices are focused for batch brewing, with limited control over water dispensing amounts, coffee exposure to water, and even exposure of coffee grounds to water. With regular shower heads, coffee grounds on the side tend to receive less water, and will have uneven brewing temperature, causing flaws in the brewing process. Furthermore, with showerheads or motionless dispensers that are large enough to cover all the ground, all the coffee gets soaked in water, pushing the grounds towards the center of the filter which can clog the filter and slow down the water flow through the coffee, hence negatively impacting the extraction. While utilizing a showerhead to dispense water over coffee ground can result in a good cup of coffee, it is not consistent with a proper pour-over technique and does not achieve full flavor profile potential of the coffee bean.

Devices that produce spiral-like or spiral dispensing of water generally utilize a dual motor system, such as patents KR-102208767-B1, CN-103829802-B, KR-20160121202-A, KR-20200100520-A, KR-101975380-B1, U.S. Pat. No. 10,729,278-B2, and/or a complicated mechanical systems with multiple systems or driving devices, such as U.S. Pat. No. 8,752,476-B2 which utilizes a driving motor, a shifting mechanism, a driving shaft, and a swing device, and device under patent JP-2019531104-A which utilizes a system of gears of belts. Devices that utilize a dual motor system and/or complicated mechanisms are more prone to failures, require higher energy to operate, and are more difficult to produce, maintain, and repair.

Furthermore, available devices that replicate the spiral-like motion, such as the invention under U.S. Pat. No. 10,143,331-B1 utilizes a complex and limited mechanism that is very costly to develop, maintain and replicate for a single cup device. Hence the invention under U.S. Pat. No. 10,143,331-B1 utilize a minimum of 3 cup system and is focused for commercial usage rather than at-home usage. Inventions under U.S. Pat. No. 10,143,331-B1, KR-20200054918-A, KR-101719356-B1 utilize a separate water boiler system and provides a single pre-set water temperature through the dispensing nozzle, which in turns provides one temperature across all cups. This limits the ability to control temperature across various cups and have one complete system linked to the invention.

Finally, many coffee consumers prefer predictable and repeatable quality when brewing coffee. Many coffee consumers also prefer to be able to customize the coffee brewing experience. In some cases, coffee machines that provide consistent quality cannot provide a user with the desired quality or customization of brewing. For example, some coffee machines cannot brew coffee that is at the same or better quality than a manual pour-over.

In one aspect, a coffee brewing system may be configured to automatically brew pour-over coffee. One embodiment of the coffee brewing system can be in the form of a coffee machine. By automating the pour-over brewing method, the coffee machine may achieve high quality and consistent coffee brewing. The coffee machine can free a user from having to spend 3-4 minutes preparing a cup of coffee. The coffee machine may utilize a disk mechanism that allows for spiral or spiral-like dispensing of water over the coffee ground. The construction of the disk mechanism may allow the machine to have few potential failure points, be easy to maintain and repair, and/or have a long life. The machine may automate the pour-over technique through a spiral or spiral-like water dispensing over the coffee ground, with controlled pouring stints and temperature, creating a pulse pour with timed interruptions in water dispensing through several water dispensing stints. The machine may further allow uniform dispensing of water over the coffee ground. The machine may be sized for a single or a two-cup pour-over system, or optionally as a multi-station pour-over system that may include replicating the mechanisms and elements of a single pour-over station. A recipe for brewing may refer to the number of stints, amount of water dispensed in each stint, the wait time between each stint, the temperature, and/or the target time for the brew. The coffee machine can produce a nearly infinite number of recipes for all types of coffee beans.

The brewing system may include a computer system that may have a processor and/or may be configured to control temperature, motor rotation, a pump, and/or one or more valves. In other embodiments, the brewing system may be controlled through a mobile application that may provide input for one or more variables, such as temperature, water dispensing stints, amount of water dispensed, and/or motor rotation.

In a preferred embodiment, a brewing system may be turned on through a master switch, such as on the side of a coffee machine. The brewing system may start when either the “Rinse” or the “Brew” command button is selected. When either is selected, a computer system may send a signal to a heating element to heat the water, such as a boiler, thermoblock, and/or flowthrough heating device as examples. Once the temperature sensor indicates that the water is within accepted temperature range, the system may begin the coffee making process. In one example, the temperature sensor may be utilized in a thermostat and/or with a proportional integral derivative (PID) controller. In one embodiment, the target temperature may be set by the user through a touch screen display and/or through a mobile application.

If a user selects a “Rinse” command, the water nozzle may start from the outmost point of a spiral opening and/or the pump may move water to be dispensed from the nozzle. At the same time, the motor may start rotating the nozzle inward through the spiral opening. The Rinse command may stop when the nozzle reaches a central point of the spiral. During the rinse period, a user may not be able to provide any other command until the rinse is complete. A user may stop the system anytime by turning off the master switch. Once the rinse process is complete and/or if an individual operating the machine decides not to rinse, then the system may present options to “Brew.” A rinse command may be performed to rinse the filter prior to adding coffee grounds for the brewing process.

If a user selects “Brew,” the system may start when the Brew command is pressed. A first water dispensing stint may be called the “blooming” stint. The motor may turn on while the pump is off so as to push the nozzle toward the center in a rapid way. Once the nozzle is the center, a pump may be activated to dispense water on the coffee bed. Optionally, the water nozzle may start from the outmost point of the spiral opening, the pump may turn on dispensing water for a few seconds, and/or the motor may start rotating the disk mechanism to move the nozzle outward through the spiral guide while dispensing hot water. A blooming stint may stop when the nozzle reaches the outmost outer part of the spiral guide. The system may pause for some time, typically 20 to 45 seconds for example, so as to allow the blooming to complete. In a preferred embodiment, a user may choose the quantity of water released during a Blooming phase and/or the wait time after a Blooming phase.

Once the post-blooming pause time elapses, the computer may signal the pump, motor, to start again, dispensing water while the tube rotates through the spiral from outside to the inside. The process will repeat 3 to 8 times, with different time for the water dispensing or the wait time.

In a preferred embodiment, the timing and target water dispensing amount for a complete “Brew” process may be configured as shown in the following tables. Optionally, such settings may be changed either by the manufacturer and/or by the customer through an application:

Example 1-pouring 240 ml in 4.2 minutes onto 16 grams of coffee grounds.

| | Water | | Dispensing | | Wait time | |
|---|---|---|---|---|---|---|
| Stints | Amount | | time | | after | Rotation Direction |
| Stint 1 - | 30 | ml | 8 | seconds | 30 seconds | Inside to outside of |
| Bloom | | | | | | spiral |
| Stint 2 | 50 | ml | 12 | seconds | 35 seconds | Outside to inside of |
| | | | | | | spiral |
| Stint 3 | 50 | ml | 12 | seconds | 35 seconds | Outside to inside of |
| | | | | | | spiral |
| Stint 4 | 50 | ml | 12 | seconds | 35 seconds | Outside to inside of |
| | | | | | | spiral |
| Stint 5 | 60 | ml | 15 | seconds | 60 seconds | Outside to inside of |
| | | | | | | spiral |

| | | | |
|---|---|---|---|
| Total | 240 | ml | 4 minutes 14 seconds |

Example 2-pouring 350 ml in 5.3 minutes onto 20 grams of coffee grounds.

| | Water | | Dispensing | Wait time | |
|---|---|---|---|---|---|
| Stints | Amount | | time | after | Rotation Direction |
| Stint 1 - | 45 | ml | 12 seconds | 30 seconds | Inside to outside of |
| Bloom | | | | | spiral |
| Stint 2 | 60 | ml | 15 seconds | 35 seconds | Outside to inside of |
| | | | | | spiral |
| Stint 3 | 60 | ml | 15 seconds | 35 seconds | Outside to inside of |
| | | | | | spiral |
| Stint 4 | 60 | ml | 15 seconds | 35 seconds | Outside to inside of |
| | | | | | spiral |
| Stint 5 | 60 | ml | 15 seconds | 35 seconds | Outside to inside of |
| | | | | | spiral |
| Stint 6 | 65 | ml | 16 seconds | 60 seconds | Outside to inside of |
| | | | | | spiral |

| | | | |
|---|---|---|---|
| Total | 250 | ml | 5 minutes 18 seconds |

In one embodiment, a brewing system may include a reverse pump and/or multi-way valve to pull water backward during a “wait” time, such as moving water all the way from the nozzle back to a water tank or a water drain. By moving water in this way, the brewing system may prevent water from dripping and/or ensure that only hot water is dispensed.

In a preferred embodiment, the brewing system may be controlled through 3 or 4 buttons and/or a touch screen display that may allow a user to customize brewing variables. The variables may include the water temperature, dispensing amount, wait times, and/or number of stints. Such “Recipes” may be saved and/or recalled at any time using the touch screen display.

In another embodiment, the invention may be controlled through a phone application that may be wirelessly linked to the brewing system using Bluetooth and/or Wi-Fi. The application may allow the user to control the water temperature, dispensing amount, wait times, and/or number of stints through an application interface that may optionally be uploaded wirelessly from the application to a control unit in the machine.

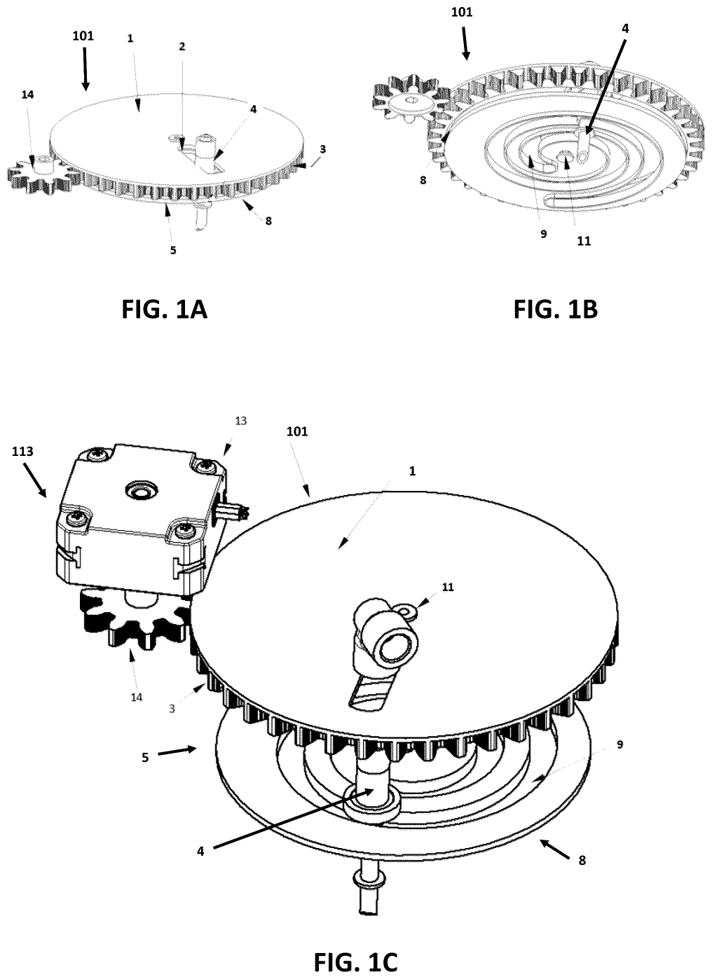

Referring now to the figures, FIGS. 1A, 1B, and 1C show a disk mechanism 101 and a nozzle 4. In one embodiment, the disk mechanism 101 and the nozzle 4 may be installed in an automated pour-over coffee machine. Generally, the disk mechanism 101 may couple to a nozzle 4 and/or move the nozzle 4 along a desired path. The nozzle 4 is typically configured to dispense a fluid, such as water. The disk mechanism 101 and the nozzle 4 may be used to automatically make pour-over coffee by dispensing water in a pattern over coffee grounds. For example, when the disk mechanism 101 and the nozzle 4 are positioned over a receptacle that contains coffee grounds, the nozzle 4 may dispense water onto the coffee grounds, and/or the disk mechanism 101 may move the nozzle 4 as the nozzle 4 dispenses the water. As should be appreciated, the disk mechanism 101 and/or the nozzle 4 could be used in other applications that require dispensing a fluid in a desired pattern.

In the illustrated embodiment, the disk mechanism 101 may include an upper disk 1 and a lower disk 8. Upper disk 1 may define a radial opening 2 that extends along upper disk 1 in a radial direction from the center of the disc towards the outer edge of the disc, typically in a linear manner. Lower disk 8 may define a guide opening 9 that extends along lower disk 8 in an arc and/or a whorl. Both the radial opening 2 and the guide opening 9 may be configured to receive the nozzle 4. When the upper disk 1 and lower disk 8 are assembled, the radial opening 2 and the guide opening 9 may align at one or more points. The radial opening 2 and guide opening 9 may allow the nozzle 4 to pass through the disk mechanism 101 in a longitudinal direction.

The guide opening 9 may be generally configured to direct the nozzle 4 along a desired path. In the illustrated embodiment, the guide opening 9 may be shaped as an arc, a whorl, and/or a spiral. For example, the spiral shape may extend from a central or nearly central point and along a curve as the disc rotates. Such a curve may emanate outward from the point such that the curve is positioned further from that point at each revolution. In another example, the guide opening 9 may be a spiral-like shape that is similar to a spiral shape or whorl in one or more characteristics. The spiral shape may be similar to the pattern in which water is poured when a user manually makes traditional pour-over coffee. In this way, the guide opening 9 may direct the nozzle 4 in a spiral pattern so as to approximate a traditional pouring pattern. Alternatively, the shape of the guide opening 9 could be varied so as to guide the nozzle 4 in any pattern or shape that extends towards the outer edge of the disc as the disc is rotated.

The upper disk 1 and the lower disk 8 are typically rotatably coupled together. In the illustrated embodiment the lower disk 8 may be fixed while the upper disk 1 rotates. The upper disk 1 and lower disk 8 may be coupled using a central locking piece 11. The central locking piece 11 may fix the lower disk 8 to the upper disk 1 in a longitudinal direction while allowing the upper disk 1 to rotate relative to the lower disk 8. The central locking piece 11 may be positioned in the center of both the upper disk 1 and lower disk 8 so as to allow uniform rotation of the upper disk 1 about the central locking piece 11 relative to the lower disk 8. As should be appreciated, the upper disk 1 and lower disk 8 could be aligned and/or coupled in another way, such as through a guide or support structure positioned outside the disk mechanism 101 as examples.

The disk mechanism 101 may include a low-friction portion 5 that is made of a low-friction material, such as TEFLON (Polytetrafluoroethylene), Acetal, POM (Polyoxymethylene), and/or another material. The low-friction portion 5 may reduce friction between the upper disk 1 and the lower disk 8 as the upper disk 1 rotates relative to the lower disk 8. In the illustrated example, the upper disk 1 may contact the lower disk 8 as the upper disk 1 rotates. The low-friction portion 5 may be positioned at the portions of the upper disk 1 and lower disk 8 that contact each other. In one example, the upper disk 1 and lower disk 8 may contact each other along a small surface area, and/or the low-friction portion 5 may extend only on a small surface area where the upper disk 1 and lower disk 8 may contact. Using the low-friction portion 5, the frictional force between the upper disk 1 and lower disk 8 may be low, which may support smooth and quiet operation of the disk mechanism 101. Alternatively, low-friction portion 5 may extend across a larger section of the upper disk 1 and/or lower disk 8. For example, the upper disk 1 and/or lower disk 8 could be completely made of a low-friction material. As should be appreciated, the disk mechanism 101 could support smooth and/or low-friction rotation in another way, such as using bearings and/or a lubricant as examples.

In the illustrated embodiment, the disk mechanism 101 may be mechanically linked to a drive system 113. The drive system 113 may include a motor 13 and/or a motor gear 14. For example, the motor 13 may be an electric motor, such as a stepper motor. The motor 13 may rotate the upper disk 1 through the gear motor 14 and/or another linkage. The upper disk 1 may include teeth 3 that may link to the motor 13 through the motor gear 14. In the illustrated embodiment, the teeth 3 may be positioned around the circumference of the upper disk 1 and/or may be oriented in a radial direction. As illustrated, the motor gear 14 and teeth 3 may be arranged to interface and/or rotate in the same plane. Alternatively, the teeth 3 may be oriented in a longitudinal direction relative to the upper disk 1. The motor gear 14 could optionally be oriented in a transverse direction to the teeth 3, and/or the motor gear 14 could include a worm gear, a helical gear, a bevel gear, and/or another type of gear. As should be appreciated, the motor 13 could link to the upper disk 1 through a belt, a chain, and/or another device.

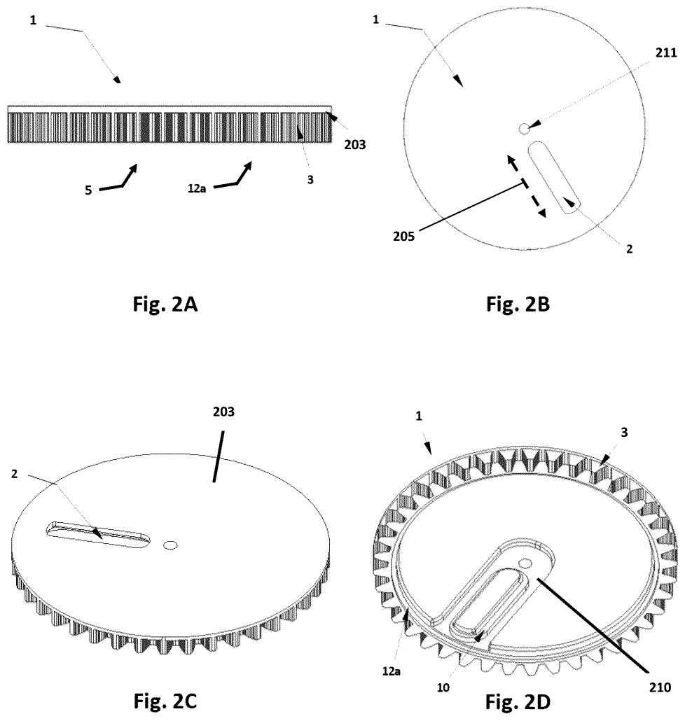

FIGS. 2A, 2B, 2C, and 2D illustrate one embodiment of the upper disk 1. The upper disk 1 may be generally cylindrically shaped and/or may be made of a rigid material that generally maintains a consistent shape. By using a rigid material, the upper disk 1 may structurally support the nozzle 4 and/or the lower disk 8. The rigid material may help to ensure that the upper disk 1 interacts reliably with the nozzle 4 and/or the lower disk 8. In one example, the upper disk 1 may be made of a low-friction material that is rigid. Further, the upper disk 1 may be integrally formed as a single piece of material, for example by casting the upper disk 1 using a mold. As should be appreciated, the shape, material, and/or other characteristics of the upper disk 1 could be varied from the illustrated embodiment.

The upper disk 1 may further include a plate 203, a support 210, and/or an edge surface 12a. The plate 203 may extend across an upper portion of the upper disk 1. The upper disk 1 may define the radial opening 2 fully through plate 203. In the illustrated example, plate 203 may extend across the entire upper portion of the upper disk 1 and/or extend above the teeth 3. In one example, the plate 203 may provide a barrier between the lower plate 8 and/or other components of a coffee machine. Alternatively, one or more portions of the plate 203 may be removed and/or shaped differently to reduce weight and/or adjust the functionality of the plate 203.

As illustrated, the radial opening 2 may extend fully or partially in a radial direction 205. The radial direction 205 may be oriented outward from a central point and/or towards an outer edge of the upper disk 1. In one example, the radial direction 205 may extend exactly along a radius of the upper disk 1. Alternatively, the radial direction 205 may refer to any direction that is oriented toward or away from a center of the upper disk 1. Generally, the radial direction 205 may be oriented within a plane defined by the upper disk 1. The radial opening 2 may be centered along a radius emanating from the center of the upper disk or may be offset from the radius and/or the center. In one example, a width of the radial opening 2 in one direction may be based on a width of the nozzle 4. For instance, the radial opening 2 may be shaped such that a width of the radial opening 2 is within a tolerance of a width of the nozzle 4. In such an example, the tolerance may be within 5 mm, 1 mm, 0.5 mm, and/or another length. In the illustrated example, the radial opening 2 may be shaped with a consistent width. The shape of the radial opening 2 may generally define a path on which the nozzle 4 may travel relative to the upper disk 1. As should be appreciated, the radial opening 2 could be shaped in another way so as to limit or allow the nozzle 4 to move in a different way relative to the upper disk 1.

The support 210 may be positioned on a bottom portion of the upper disk 1. Generally, the support 210 may have a greater thickness in a longitudinal direction than the plate 203. The support 210 may provide structural support for the upper disk 1, especially if the plate 203 is relatively thin compared to the support 210. In the illustrated example, the support 210 may be positioned around the radial opening 2, and/or the radial opening 2 may extend through the support 210. Positioning the support 210 around the radial opening 2 may provide reliable support for the nozzle 4 when the nozzle 4 is positioned in the radial opening 2.

As shown, the support 210 may define a rail 10. In the illustrated embodiment, the rail 10 may extend around the radial opening 2 on all sides. The rail 10 may be configured to receive a portion of the nozzle 4. Using the rail 10, the upper disk 1 may maintain a desired orientation of the nozzle 4 within the radial opening 2 and/or support the nozzle 4 to slide along the radial opening 2. For example, the rail 10 may support the nozzle 4 in a perpendicular orientation relative to the plane of movement of the nozzle 4. By maintaining such an orientation, the nozzle 4 can define a consistent cross-sectional shape through the radial opening 2 as the disk mechanism 101 operates and/or moves the nozzle 4. The consistent orientation and alignment may facilitate reliable operation of the disk mechanism 101 and/or the nozzle 4.

The edge surface 12a may be positioned on a lower side of the upper disk 1. When upper disk 1 and lower disk 8 are assembled, the edge surface 12a may contact the lower disk 8. As the upper disk 1 rotates relative to the lower disk 8, the edge surface 12a may slide along the lower disk 8. The edge surface 12a may have a relatively small surface area compared to the size of the upper disk 1 so as to reduce the frictional force between the upper disk 1 and lower disk 8 during rotation. Using a small surface area may also help to keep noise at a quiet level during rotation. Typically, the low-friction portion 5 includes the edge surface 12a and/or the edge surface 12a may be made of a low-friction material.

The upper disk 1 may further define a lock opening 211 that may receive the central locking piece 11. In the illustrated example, the upper disk 1 may define the lock opening 211 through the support 210. By positioning the support 210 around the lock opening 211, the support 210 may facilitate a stable coupling between the upper disk 1 and lower disk 8 using the central locking piece 11.

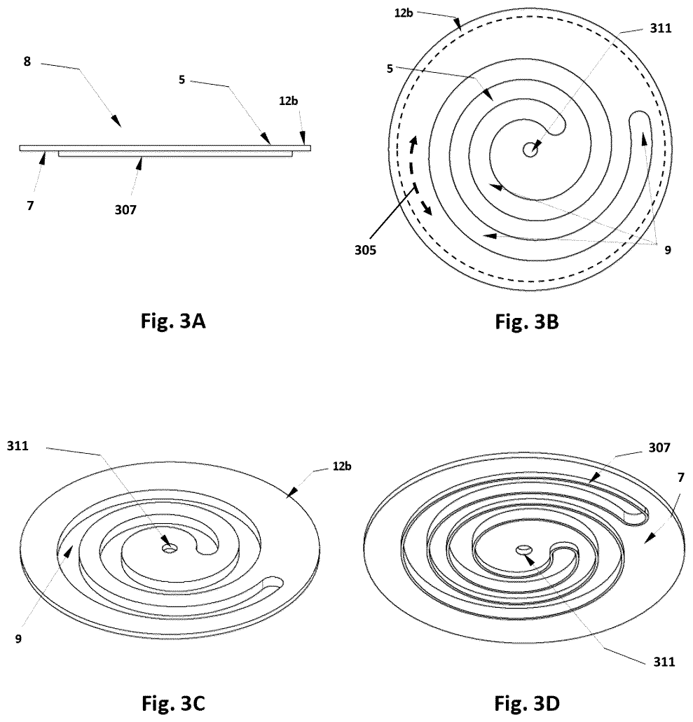

FIGS. 3A, 3B, 3C, and 3D illustrate one embodiment of the lower disk 8. The lower disk 8 may be generally cylindrically shaped and/or may be made of a rigid material that generally maintains a consistent shape. By using a rigid material, the lower disk 8 may structurally support the nozzle 4 and/or the upper disk 1. The rigid material may help to ensure that the lower disk 8 interacts reliably with the nozzle 4 and/or the upper disk 1. In one example, the lower disk 8 may be made of a low-friction material that is rigid. Similar to the upper disk 1, the lower disk 8 may be integrally formed as a single piece of material, for example by casting the lower disk 8 using a mold. As should be appreciated, the shape, material, and/or other characteristics of the lower disk 8 could be varied from the illustrated embodiment.

The lower disk 8 may further include a body 7, a rim 307, and/or a coupling surface 12b. The body 7 may be a uniform thickness across the lower disk 8. As illustrated, the guide opening 9 may extend fully through the body 7. The body 7 may additionally define a lock opening 311 that may receive the central locking piece 11. The lock opening 311 may be positioned in the center of the lower disk 8 to allow uniform rotation of the lower disk 8 relative to the upper disk 1.

As illustrated, the guide opening 9 may extend at least partially in an arc, whorl, or swirl in a circumferential direction 305 along the lower disk 8. The circumferential direction 305 may generally be oriented around a center of the lower disk 8 such that the circumferential direction 305 curves around the center of the lower disk 8. In one example, the circumferential direction 305 may be oriented along a curve and/or line that is tangential to a circle and/or curve that is concentric with the lower disk 8. The circumferential direction 305 may not necessarily extend along an outer portion of the lower disk 8 and/or may be oriented parallel to an outer circumference of the lower disk 8. Typically, the circumferential direction 305 may be transverse or perpendicular to a radial direction on the lower disk 8. In one example, a radial direction on the lower disk 8 may refer to the same direction as the radial direction 205 on the upper disk 1, shown in FIG. 2B, when the upper disk 1 and lower disk 8 are aligned. In such an example, a circumferential direction on the upper disk 1 may refer to the same direction as the circumferential direction 305 on the lower disk 8. The guide opening 9 may additionally extend in a radial direction along the lower disk 8, such as in the radial direction 205 in FIG. 2B. The innermost point of the guide opening 9 may be spaced away from the center of the lower disk 8.

In the illustrated example, the guide opening 9 may be whorl shaped, spiral shaped or spiral-like in shape. The shape may extend from a central or nearly central point and along a curve that revolves around that point. Such a curve may emanate outward from the point such that the curve is positioned further from that point at each revolution. The spiral shape may include any type of spiral, such as a spiral with consistent spacing between revolutions, a spiral with spacing that continuously changes between revolutions, and/or another type of spiral. A spiral shape may extend around a central or nearly central point along a round curve, along multiple straight segments, and/or along a combination of round and straight segments. In another example, the guide opening 9 may be a spiral-like shape that is similar to a spiral shape in one or more characteristics. For instance, a spiral-like shape may extend along a portion of a spiral, such as a curve that only partially revolves around a central or nearly central point. The guide opening 9 could alternatively be shaped another way, such as a shape that is uniform, oscillating, and/or varying in another way in the circumferential direction 305 along the lower disk 8. For example, the guide opening 9 could be shaped to mimic another pattern that is utilized for pouring water over coffee grounds when making pour-over coffee.

In one example, a width of the guide opening 9 in one direction may be based on a width of the nozzle 4. For instance, the guide opening 9 may be shaped such that a width of the guide opening 9 is within a tolerance of a width of the nozzle 4. In one example, the tolerance may be within 5 mm, 1 mm, 0.3 mm, and/or another length. In the illustrated example, the guide opening 9 can be shaped with a consistent width measured along a radial direction. The shape of the guide opening 9 may generally define a path on which the nozzle 4 may travel relative to the lower disk 8. As should be appreciated, the guide opening 9 could be shaped in another way so as to limit or allow the nozzle 4 to move in a different way relative to the lower disk 8.

The rim 307 may extend around the guide opening 9. Generally, the rim 307 may have a greater thickness in a longitudinal direction than the body 7. By having a greater thickness, the rim 307 may reinforce the rigidity of lower disk 8. Further, the rim 307 may facilitate maintaining the desired orientation of the nozzle 4 within the guide opening 9. For example, the rim 307 may maintain a longitudinal orientation of the nozzle 4 as the nozzle 4 travels along the guide opening 9. Maintaining the desired orientation of the nozzle 4 may ensure reliable and consistent operation of the disk mechanism 101 and/or nozzle 4.

The coupling surface 12b may be positioned on an upper side of the lower disk 8. In the illustrated example, the coupling surface 12b may extend circumferentially around the guide opening 9. When upper disk 1 and lower disk 8 are assembled, the coupling surface 12b may contact the upper disk 1. As the upper disk 1 rotates relative to the lower disk 8, the edge surface 12a of the upper disk 1 may slide along the coupling surface 12b on the lower disk 8. The coupling surface 12b may contact the edge surface 12a along a relatively small surface area compared to the size of the lower disk 8. Contacting along a small surface area may reduce the frictional force between the upper disk 1 and lower disk 8 during rotation and/or may keep noise at a quiet level during rotation. Typically, the low-friction portion 5 may include the coupling surface 12b and/or the coupling surface 12b may be made of a low-friction material. In one embodiment, the low-friction portion 5 may extend only across the edge surface 12a and the coupling surface 12b.

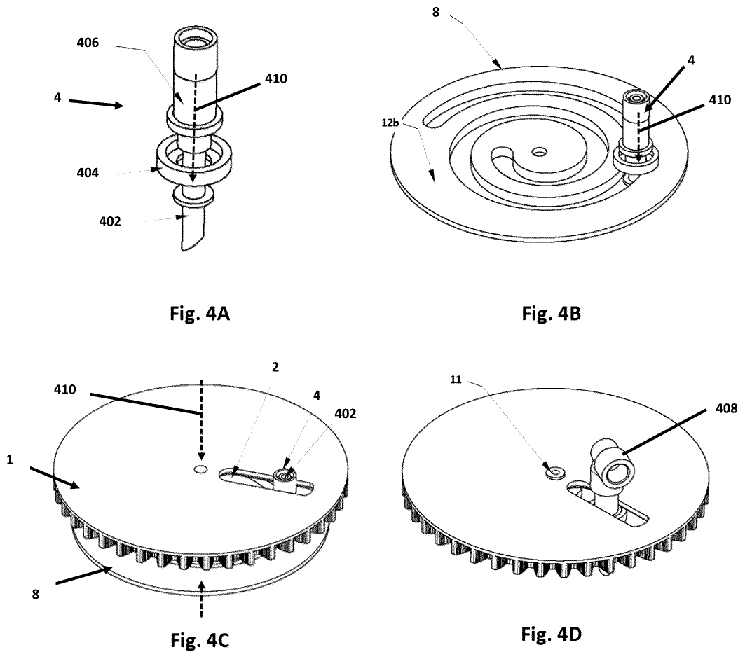

FIGS. 4A, 4B, 4C, and 4D illustrate various steps of assembling the disk mechanism 101 and the nozzle 4 in one embodiment. The disk mechanism 101 and/or nozzle 4 may be assembled by an operator, for example manually by a human or automatically by a machine. Referring to FIG. 4A, the nozzle 4 may include a nozzle pipe 402, a nozzle ring 404, and/or a nozzle base 406. The nozzle pipe 402 may typically be hollow and/or define a space for fluid to flow. The nozzle ring 404 may be generally annular in shape and/or be configured to receive the nozzle pipe 402. The nozzle base 406 may couple around the nozzle pipe 402 and/or may provide structural stability for the nozzle 4. In one example, the nozzle pipe 402 and/or the nozzle ring 404 may define round cross-sections so as to allow the nozzle pipe 402 to rotate within the nozzle ring 404. An operator may assemble the nozzle 4 by sliding the nozzle pipe 402 into the nozzle ring 404 in a longitudinal direction. In the illustrated example, the nozzle base 406 may limit the movement of nozzle pipe 402 relative to the nozzle ring 404 in the longitudinal direction 410. As should be appreciated, the nozzle 4 could be constructed in a different way and/or formed as a single piece of material.

Referring to FIG. 4B, the nozzle 4 may be positioned within the guide opening 9 of lower disk 8. An operator may slide the nozzle 4 in the longitudinal direction 410 from an upper end of the lower disk 8 through the guide opening 9. In the illustrated example, the nozzle pipe 402 may be positioned in the guide opening 9 and/or the nozzle ring 404 may be positioned against the lower disk 8 outside the guide opening 9. The guide opening 9 may be sized to closely match a width of the nozzle pipe 402. The nozzle ring 404 may limit the movement of the nozzle 4 in the longitudinal direction 410 within the guide opening 9. In one example, the nozzle ring 404 may contact the lower disk 8 on the low-friction portion 5 so as to support low frictional force between the nozzle 4 and lower disk 8. Further, the nozzle ring 4 may be made of a low-friction material.

Referring to FIG. 4C, the upper disk 1 may be positioned onto the lower disk 8 and/or the nozzle 4. An operator may move the upper disk 1 in the longitudinal direction 410 while aligning the nozzle 4 with the radial opening 2 on the upper disk 1. The operator may also align the center of the upper disk 1 with the center of the lower disk 8, for example by aligning the lock opening 211 on the upper disk 1 with the lock opening 311 on the lower disk. In the illustrated example, the nozzle base 406 and/or nozzle pipe 402 may extend through the radial opening 2. When the nozzle 4 is positioned through the radial opening 2, the nozzle ring 404 may align with the rail 10 of the upper disk 1, as shown in FIG. 2D. Positioning the nozzle ring 404 in the rail 10 may maintain the orientation of the nozzle 4 along the longitudinal direction 410. In one example, the low-friction portion 5 may extend over the rail 10 so as to support low frictional force between the nozzle ring 404 and the upper disk 1. The rail 10 may secure the nozzle ring 404 in the longitudinal direction 410 while allowing the nozzle 4 to slide along the rail 10 and the radial opening 2.

Referring to FIG. 4D, the operator may then secure the upper disk 1 to the lower disk 8 in the longitudinal direction 410 by attaching the central locking piece 11 at the lock openings 211 and 311. When the upper disk 1 and lower disk 8 are secured in the longitudinal direction 410, movement of the nozzle 4 in the longitudinal direction 410 may be limited or even completely prevented. The nozzle ring 404 may contact the lower disk 8 to limit movement in a downward direction, and/or the nozzle ring 404 and/or the nozzle base 406 may contact the upper disk 1 to limit movement in an upward direction. By assembling the disk assembly 101 around the nozzle 4 in this way, the disk assembly 101 and nozzle 4 may be securely coupled in the longitudinal direction 410 while allowing movement of the nozzle 4 along the radial opening 2 and guide opening 9.

The nozzle 4 may further include a pipe connector 408. The pipe connector 408 may optionally be attached to the nozzle pipe 402 and/or nozzle base 406 after the nozzle 4 is positioned through the radial opening 2 and guide opening 9 of the disk mechanism 101. The pipe connector 408 may be used to connect the nozzle 4 to another water pipe or hose so as to provide water to the nozzle 4 that the nozzle 4 can dispense. In one example, the pipe connector 408 may include a swivel fitting that allows the nozzle 4 to rotate relative to the water pipe or hose.

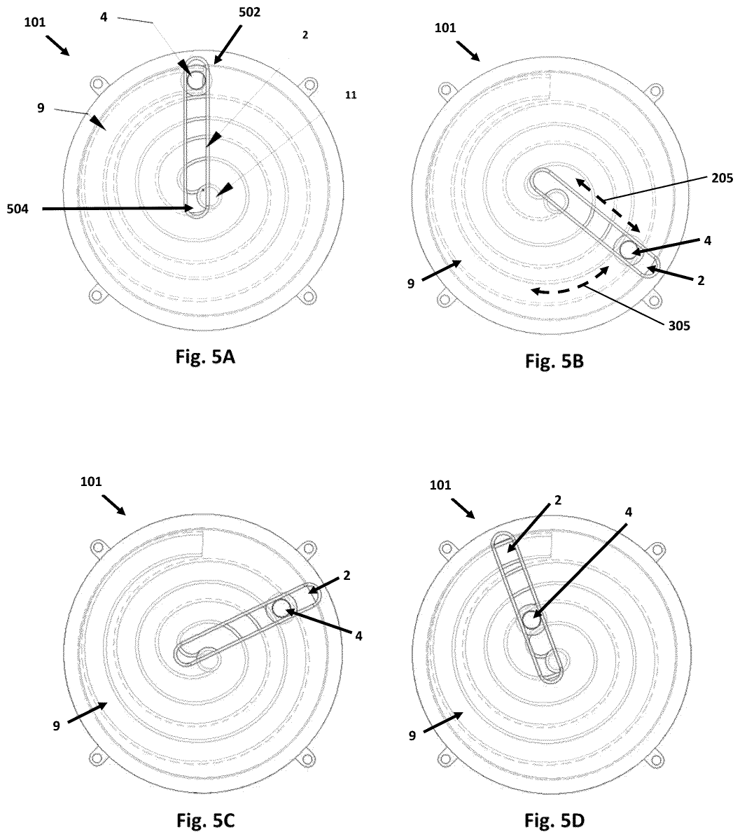

FIGS. 5A, 5B, 5C, and 5D illustrate various positions of the nozzle 4 as the disk mechanism 101 operates according to one embodiment. As shown in FIGS. 4B, 4C, and 4D, the nozzle 4 may pass through the radial opening 2 of the upper disk 1 and through the guide opening 9 of the lower disk 8. As the upper disk 1 rotates, the upper disk 1 may push the nozzle 4 along the guide opening 9. The guide opening 9 may direct the nozzle 4 as the upper disk 1 moves the nozzle 4 in the radial direction 205. By directing the nozzle 4 in a spiral shape using the guide opening 9, the nozzle 4 may dispense water in a spiral or spiral-like motion. As shown, the central locking mechanism 11 may rotatably couple the upper disk 1 and lower disk 8 around a common central point so as to ensure reliable operation of the disk mechanism 101. Further, the nozzle ring 404 may allow the nozzle pipe 402 and/or nozzle base 406 to rotate relative to the upper disk 1. By allowing the nozzle 4 to rotate, the nozzle ring 404 may prevent a hose or tube connected to the nozzle 4 from becoming tangled as the upper disk 1 moves the nozzle 4.

FIG. 5A illustrates the nozzle 4 positioned at an outer end 502 of the guide opening 9. In one embodiment, the nozzle 4 may be initially positioned at the outer end 502 of the guide opening 9 and/or the upper disk 1 may move the nozzle 4 toward an inner end 504 of the guide opening 9 near the center of the lower disk 8. As shown in FIGS. 5B, 5C, and 5D, the disk mechanism 101 may move the nozzle 4 further along the guide opening 9. As the position of the nozzle 4 changes along the guide opening 9, the position of the nozzle 4 may also change along the radial opening 2. Generally, the position of the nozzle 4 may move along the circumferential direction 305 relative to the lower disk 8, and/or the position of the nozzle move along the radial direction 205 relative to the upper disk 1 and/or lower disk 8. As should be appreciated, the nozzle 4 could be initially positioned at the inner end 504 or at another position along of the guide opening 9. Further, the disk mechanism 101 could move the nozzle 4 in a variety of ways, such as changing the direction of movement one or more times before the nozzle 4 reaches the outer end 502 or inner end 504.

In one embodiment, the nozzle 4 and/or the lower disk 8 may include a limit switch. For example, the lower disk 8 may include a limit switch at one or more ends of the guide opening 9. When a limit switch is pressed by the nozzle 4 contacting an end of the guide opening 9, the motor 13 may be configured to reverse and/or stop the rotation the upper disk 1. As should be appreciated, the disk mechanism 101, motor 13, and/or nozzle 4 could include another device to determine the position of the nozzle 4 within the guide opening 9, such as a rotary encoder and/or an optical sensor as examples.

By controlling the movement of the nozzle 4 around the guide opening 9, the disk mechanism 101 may allow a user to control the pouring of water onto coffee grounds in a specific way. In contrast to a showerhead or other type of water dispensing arrangement in other coffee machines, the disk mechanism 101 and nozzle 4 may dispense water in a precise area, in a precise pattern, and/or in a precise direction along the pattern. A precise pouring direction, pattern, and/or area may be necessary to brew certain types of coffees with a high quality. As illustrated, the disk mechanism 101 may move the nozzle 4 from the outer end 502 to the inner end 504 to dispense water in an out-to-in pattern. Alternatively, the disk mechanism 101 may move the nozzle 4 from the inner end 504 to the outer end 502 to dispense water in an in-to-out pattern. In another example, the disk mechanism 101 may maintain the position of the nozzle 4 near the inner end 504 to allow the nozzle 4 to dispense water only in the center of coffee grounds. By supporting precise control over movement of the nozzle 4, the disk mechanism 101 may allow a user to brew high quality coffee in a precise way.

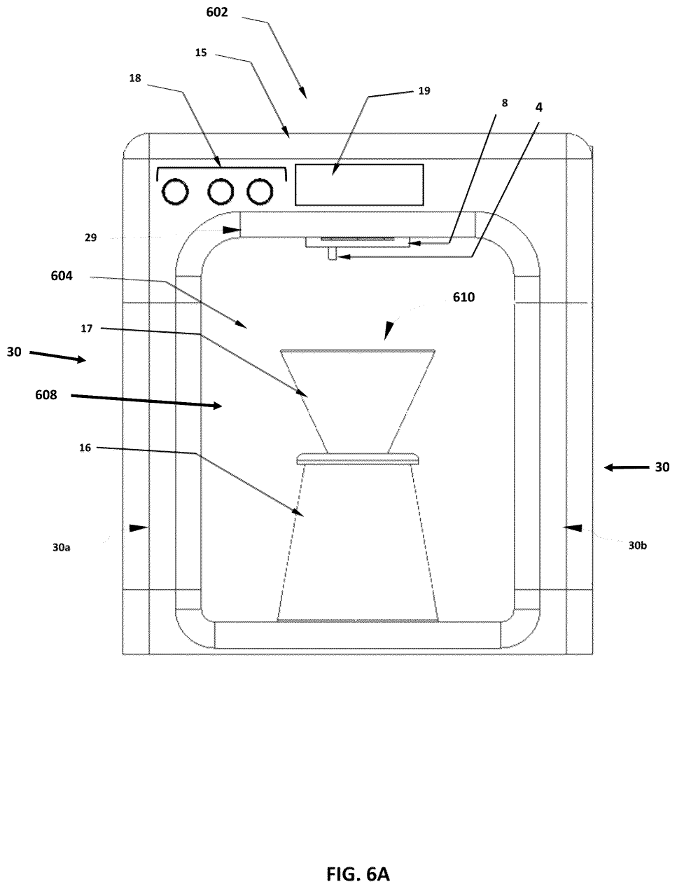

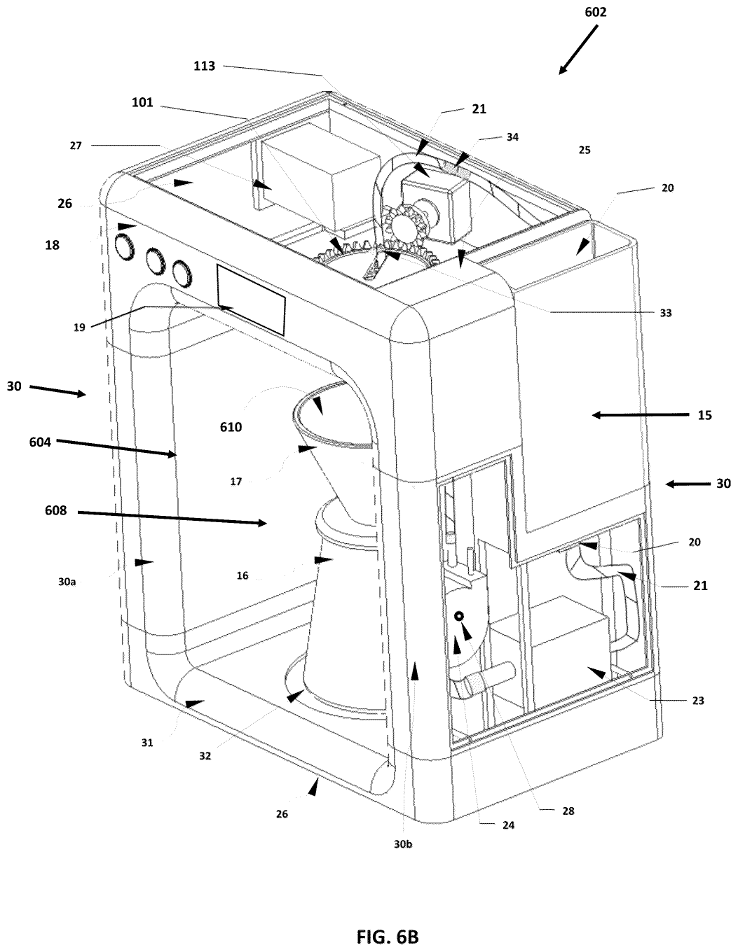

Referring to FIGS. 6A and 6B, one embodiment of a coffee machine 602 is illustrated. The coffee machine 602 may comprise a main body 15, a receptacle 608, a water tank 20, a pump 23, a heater 24, and/or a control unit 26. The coffee machine 602 may further comprise one or more versions of the disk mechanism 101, the nozzle 4, and/or the drive system 113 shown in FIGS. 1A and 1B.

The main body 15 may be generally configured to support the components of the coffee machine 602. The main body 15 may comprise an upper rack 29, side supports 30, and/or a lower rack 31. As illustrated, the main body 15 may define a central cavity 604 that provides a space for the receptacle 608. In the illustrated example, the side supports 30 may include a right support 30a and a left support 30b that may bound the central cavity 604 on the lateral sides. The central cavity 604 may extend fully through the main body 15 from a front side to a rear side. By constructing the main body 15 this way, a user may interact with the receptacle from both a front side and a rear side. Further, the central cavity 604 may allow the pour-over coffee making process to be observed from both a front side and a rear side. For example, a customer on one side may watch a user on the opposite side prepare the coffee machine 602 and then may watch as the coffee machine 602 makes coffee. The central cavity 604 may allow a user to prepare and/or place the receptacle 608 through one side of the coffee machine 602 and then may allow a customer to remove the receptacle 608 from another side of the coffee machine 602.

The upper rack 29 may be generally configured to support components of the coffee machine 602 above the receptacle 608. For example, the upper rack 29 may support the disk mechanism 101 and/or the nozzle 4 above the receptacle 608 to allow the nozzle 4 to dispense water onto the receptacle in a desired pattern. The lower rack 31 may be generally configured to support the receptacle 608. In one embodiment, the coffee machine 602 may include a removable tray 32. The removable tray 32 may capture any coffee that spills from the receptacle 608 and/or any other liquid from the nozzle 4 or another source. The tray 32 may be removed to be cleaned. In additional embodiments, the coffee machine 602 may include a heating plate that is configured to keep coffee in the receptacle 608 warm and/or reheat coffee in the receptacle 608.

The receptacle 608 may include a flask 16 and/or a dripper 17. Generally, the dripper 17 may be positioned above the flask 16. The dripper 17 may define an upper opening 610. The upper opening 610 may hold coffee grounds that may be used for brewing pour-over coffee. When the receptacle 608 is positioned under the nozzle 4, the nozzle 4 may dispense water into the upper opening 610. In the illustrated embodiment, the dripper 17 may be generally frustoconical in shape. The frustoconical shape may direct water towards the center of the dripper 17 as water flows downwards. The flask 16 may receive and/or retain coffee from the dripper 17 after the dripper 17 receives water from the nozzle 4.

As illustrated, the disk assembly 101, the nozzle 4, and/or the drive system 113 may be positioned in the upper rack 29. The motor 13 may be placed in the upper rack 29 with the motor gear 14 connected to the teeth 3 of the upper disk 3. In the illustrated embodiment, part of the lower disk 8 and/or the nozzle 4 may protrude from a lower portion of the upper rack 29. Alternatively, the disk mechanism 101 and/or nozzle 4 may be fully hidden within the upper rack 29. The nozzle 4 may be fluidly connected to a water hose 21 to connect the nozzle 4 to the pump 23 and/or to other components. The hose 21 may include multiple segments or may be a single continuous part. In the illustrated example, the hose 21 may connect to the nozzle 4 on an upper portion, such as on the pipe connector 408 shown in FIG. 4D. Further, the hose 21 may connect to the nozzle 4 through a fitting element 33. In an alternative embodiment, the hose 21 may connect to the nozzle 4 on a bottom portion. In the illustrated embodiment, the water hose 21 may be split by a swivel fitting 34 and/or the fitting element 33 may include a swivel fitting 34. The swivel fitting 34 may allow the disk mechanism 101 to avoid tangling the water tube 21 when moving of the nozzle 4. Alternatively or additionally, the freedom of the nozzle 4 to rotate using the nozzle ring 404, as shown in FIG. 4A, may allow the disk mechanism 101 to avoid tangling the tube 21.

The water tank 20 may be configured to store water and/or another fluid. The water tank 20 may be positioned within one of the side supports 30 or in another position in the coffee machine 602. In one embodiment, the water tank 20 may be detached to allow a user to fill the water tank 20 with water. In another embodiment, the coffee machine 602 may be connected directly to an external water source, such as through a hose or a pipe. For example, the coffee machine 602 may be connected in this way for commercial usage.

The pump 23 may be configured to move water and/or another fluid to the nozzle 4. The pump 23 may be fluidly connected to the water tank 20 through the hose 21. Typically, the pump 23 may be connected downstream from the water tank 20 such that the pump 23 may move water from the water tank 20 to the nozzle 4. In one embodiment, the pump 23 may be a two-way pump that is configured to move water in two directions. For example, the pump 23 could move water towards the nozzle 4 in one direction and/or away from the nozzle 4 in another direction along the same hose 21. Alternatively, the coffee machine 602 could include a reverse pump that is fluidly connected to the nozzle 4 through hose 21 and/or that is configured to pump water in an opposite direction to the pump 23, such as in a direction away from the nozzle 4. In another embodiment, the pump 23 may include a multi-way pump. The multi-way pump may move water from the tank 20 to the nozzle 4 along one hose 21 and may move water from the nozzle 4 back to the tank 20 and/or a drain using another hose 21. Optionally, the pump 23 could include a multi-way valve. The multi-way valve may selectively connect the pump 23 and the nozzle 4 through one hose 21 and/or may connect the pump 23 back to the tank 20 and/or a drain through another hose 21. In yet another embodiment, the coffee machine 602 may include a solenoid valve 25 that is connected to the hose 21 and/or the nozzle 4. The solenoid valve 25 may selectively open to allow fluid to flow through the nozzle 4 and/or close to prevent fluid flow out of the nozzle 4 As should be appreciated, the coffee machine 602 could include multiple types of pumps, valves, and/or other devices to control the movement of water to the nozzle 4, the tank 20, and/or to other components.

The heater 24 may be generally configured to heat water to a desired temperature for brewing coffee. The heater 24 may be connected to the pump 23, the water tank 20, and/or the nozzle 4 through the hose 21. The heater 24 may be in direct contact with the fluid in the coffee machine 602 and/or may heat the fluid through indirect contact. The heater 24 may heat the fluid as the pump 23 operates and/or may heat the fluid before the pump 23 moves the fluid to the nozzle 4. In the illustrated embodiment, the heater 24 may be connected upstream of the pump 23 such that the pump 23 may move water from the tank 20 to the nozzle 4 through the heater 24. In another embodiment, the heater 24 may be configured to heat water in the tank 20 and/or may not directly heat water in the hose 21. Further, in the illustrated embodiment, the heater 24 may be positioned in the left side support 30b along with the pump 23 and/or the water tank 20. In another embodiment, the heater 24 may be positioned in the upper rack 29 to be nearby the nozzle 4. By positioning the heater 24 near the nozzle 4, the water may lose little heat from traveling along the tube 21 and may remain hot at the nozzle 4. As should be appreciated, the heater 24, pump 23, and/or water tank 20 could be positioned and/or ordered in a variety of ways within the coffee machine 602.

The control unit 26 may generally be configured to control the operation of the motor 13, pump 23, heater 24, and/or other components in the coffee machine 602. The control unit 26 may include one or more computers, controllers, and/or other devices configured to process and store information. In the illustrated embodiment, the control unit 26 may be positioned within or beneath the lower rack 31. Alternatively, the control unit 26 could be positioned in the upper rack 29 and/or in another location. The control unit 26 may be communicatively connected to various components using a wired connection or another type of connection.

In the illustrated embodiment, the coffee machine 602 may further include a water flow sensor 22 and/or a temperature sensor 28. The control unit 26 may communicate with the water flow sensor 22 and/or temperature sensor 28. Generally, the control unit 26 may be configured to control the operation of various components based on information captured by the water flow sensor 22 and/or temperature sensor 28. The water flow sensor 22 may be positioned on the hose 21, the pump 23, the nozzle 4, and/or in another position. Using the water flow sensor 22, the control unit 26 may monitor the speed, direction, volume, and/or other characteristics of water flow in the coffee machine 602. The control unit 26 may use information about the water flow to control the operation of the pump 23, the solenoid valve 25, and/or another component. The temperature sensor 28 may be positioned on the hose 21, the heater 24, the nozzle 4, and/or in another position to measure temperature of the water. Based on the temperature information, the control unit 26 may control the operation of the heater 24 and/or another component. As should be appreciated, the coffee machine 602 could include multiple water flow sensors 22 and/or temperature sensors 28 at various positions.

In addition to the water flow sensor 22 and temperature sensor 28, the control unit 26 could utilize a variety of other sensors to control components in the coffee machine 602. In one embodiment, the control unit 26 may control the motor 13 based on information from one or more sensors that measure the speed and/or position of the disk mechanism 101 and/or motor 13. For example, the coffee machine 206 may include a rotary encoder, a limit switch, an optical sensor, a hall-effect sensor, and/or another device to measure the operation of the disk mechanism 101 and/or the motor 13. In another embodiment, the control unit 26 may use a sensor to measure the amount of water in the tank 20 and/or may control the pump 23, the solenoid valve 25, and/or another component based on information from that sensor. As should be appreciated, the control unit 26 can adjust operation of a component based on information from multiple sensors.

The control unit 26 may further include a proportional integral derivative (PID) controller 27. In one embodiment, the PID controller 27 may be used to maintain a desired temperature of the water in the hose 21 and/or tank 20. For example, the PID controller 27 may control the heater 24 based on information from the temperature sensor 28. In another embodiment, the PID controller 27 may be used to control the pump 23, the motor 13, and/or another component. Optionally, the control unit 26 may further include a motor driver to control the operation of the motor 13 and/or another part of the drive system 113. In one embodiment, the PID controller 27 and/or the motor driver may be positioned near the heater 24 and/or the motor 13. For example, the PID controller 27 and/or the motor driver may be positioned in the upper rack 29. As should be appreciated, the control unit 26 may include one or more controllers and/or other devices configured to control the operation of a specific component or specific group of components.

By controlling the operation of the drive system 113, pump 23, heater 24, and/or solenoid valve 25, the control unit 26 may allow the coffee machine 206 to make coffee in precise ways. For example, the control unit 26 may operate the pump 23 and/or solenoid valve 25 to dispense a desired amount of water through the nozzle 4 at a desired speed for a desired amount of time. The control unit 26 may operate the drive system 113 to move the nozzle 4 at a desired speed and/or direction along the guide opening 9 and/or from a desired starting position. The control unit 26 may operate the heater 24 to heat the water to a desired temperature. Further, the coffee machine 206 may pour water in multiple stints when making coffee and/or may adjust various parameters between stints, such as temperature, pour time, wait time between stints, direction of movement of the nozzle 4, and/or pour amount. In one example, the control unit 26 may operate the pump 23 and/or solenoid valve 25 to move water away from the nozzle 4 and/or to prevent water from moving out the nozzle 4. For instance, the pump 23 and/or solenoid valve 25 may operate this way when the water is not at a desired temperature and/or when waiting between stints.

The coffee machine 602 may be generally configured to perform a method for brewing coffee. The method may comprise rotating the first disk 1 relative to the second disk 8 using the motor 13, and/or moving the nozzle 4 using the first disk 1. The method may further comprise guiding the nozzle 4 along the guide opening 9 using the second disk 8, and/or dispensing a fluid using the nozzle 4. In one example, the method may further comprise determining the nozzle 4 is at an end of the guide opening 9 and/or moving nozzle 4 in an opposite direction using the first disk 1. In another example, the guide opening 9 may be spiral-shaped or spiral-like in shape. As should be appreciated, one or more different components of the coffee machine 602 may be configured to perform one or more parts of the method. Further, the control unit 26 may be configured to alter and/or adjust one or more parts of the method in a variety of ways and/or based on a user input.

The coffee machine 602 may further include control buttons 18 and/or a display 19. The control buttons 18 may allow a user to operate and/or change settings of the coffee machine 602. The display 19 may show information to the user, such as operational settings, brewing progress, status messages, and/or other information. The control unit 26 may operate the components in the coffee machine 602 based on inputs received through the control buttons 18. In one embodiment, the display 19 may include a touch display that may allow a user to provide inputs to the control unit 26 to change various operational parameters. In the illustrated embodiment, the buttons 18 and/or display 19 may be positioned on the upper rack 29. Alternatively, the buttons 18 and/or display 19 could be positioned in a different location, such as on the right support 30a as an example. In another embodiment, the control unit 26 may be positioned behind the display 19. Alternatively, the control buttons 18 and/or display 19 may be part of a separate device that is removable from the coffee machine 602.

In one embodiment, the coffee machine 602 may be controlled through an external device, such as a mobile phone. The device may include a touch screen to allow a user to control operational variables, such as the amount of water dispensed, the frequency of water dispensed, and/or the water temperature among other variables. The device may control the operation of the coffee machine 602 by sending signals to the control unit 26. For example, the device may send wireless signals over Wi-Fi, Bluetooth, or another type of wireless connection. Alternatively, the device could send signals to the control unit 26 over a wired connection, such as through one or more cables.

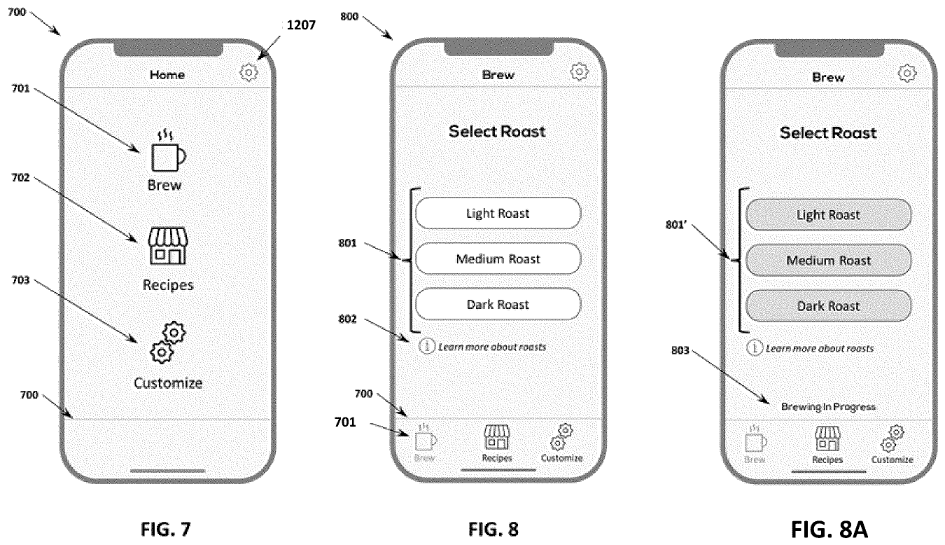

FIGS. 7-12 show exemplary user interfaces that could be instantiated on remote mobile devices that may be communicatively coupled to the control unit 26 by a cable, Wi-Fi, and/or Bluetooth as examples. In one embodiment, the FIG. 7 to FIG. 12 user interfaces may be displayed on a touch screen mobile device. In another embodiment, the user interfaces could be displayed on the display 19 and/or another touch screen display on the coffee machine 602. Alternatively, the user interfaces could be displayed on a variety of user interface devices, such as a tablet, phone, a desktop, and/or a laptop computer as examples.

FIG. 7 shows a main user interface 700. The main user interface 700 may be the landing or home page of the application. In the illustrated embodiment, the main user interface 700 may include options for a brew mode 701, a recipe mode 702, and/or a customize mode 703. The brew mode 701 may allow a user to directly select options to brew a coffee. The recipe mode 702 may allow a user to brew a coffee based on a stored recipe. The customize mode 703 may allow a user to create and/or customize a recipe. The main user interface 700 may further allow a user to manage application settings 1207.

FIG. 8 shows a first brew page 800 that may allow a user to select brewing options. When a user selects the brew mode 701, shown in FIG. 7, the mobile application may display the brew interface page 800. The brew interface page 800 may allow a user to choose a roast level 801. For example, the user may select light roast, medium roast, or dark roast using the roast level 801. The first brew page 800 may further include an information icon 802 that may provide additional information about the roast options when selected. As illustrated, the first brew page 800 may further include main user interface 700 on a bottom portion of the display. By including the main user interface 700 on a portion of the brew page 800, the user may switch between the brew mode 701, recipe mode 702, and/or customize mode 703.

FIG. 8A shows an alternate embodiment of the first brew page 800 that may be displayed when the coffee machine 602 is in the process of brewing. For example, the brew page 800 in FIG. 8A may be shown to a user while a previous command for the coffee machine 602 is finishing. In the illustrated example, the user may not be allowed to select a roast level 801′ to start brewing. The brew page 800 may include a progress message 803 to indicate brewing is already in progress. As shown in FIG. 8, the brew page 800 in FIG. 8A may display the brew mode 701, recipe mode 702, and/or customize mode 703 to allow a user can toggle between the modes at any point.

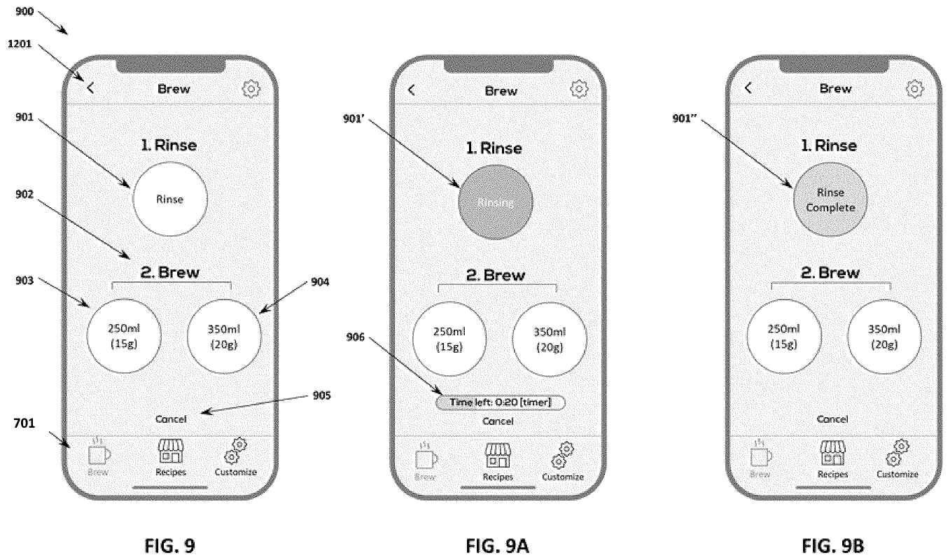

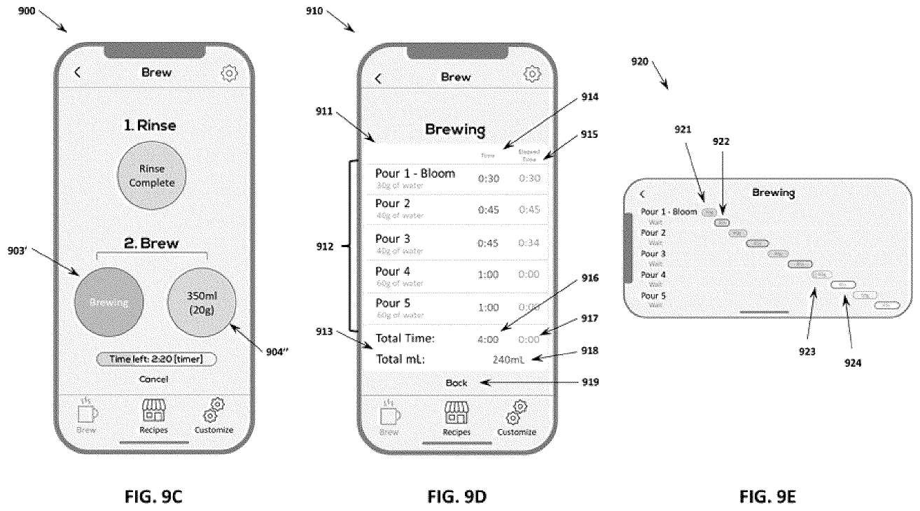

FIG. 9 shows a second brew page 900. The application may display the second brew when a user has hit the progress message 803 shown in FIG. 8 Alt. The second brew page 900 in FIG. 9 may include a rinse button 901, brew size buttons 902, and/or a cancel button 905. The brewing buttons 902 may include a small option 903 and/or a large option 904. When a user selects the rinse button 901, the coffee machine 602 may dispense water to rinse the receptacle 608. For example, the coffee machine 602 may dispense a pre-determined amount of water to rinse a filter within the dripper 17. The brew size buttons 902 may allow a user to choose between a small cup by pressing button 903, or a large cup by pressing button 904. In the illustrated example, the small option 903 may be 250 mL and the large option 905 may be 350 mL. As should be appreciated, the brew size buttons 902 could include different or additional size options. The cancel button 905 may allow a user to return to the first brew page 800 and/or may allow a user to stop any ongoing brewing processes. Further, the second brew page 900 may include a back arrow 1201 that allows a user to return to the first brew page 800.

FIGS. 9A and 9B shows the second brew page 900 after a user has selected the rinse button 901′. FIG. 9A shows the second brew page 900 while rinsing is in progress. As shown, the rinse button 901′ may change in appearance to indicate that rinsing is in progress. The second brew page 900 may optionally display a timer 906 to indicate the time remaining for the rinse to complete. In one embodiment, the application may be configured to not send a command to the coffee machine 602 if the user selects any other button while the rinse is in-progress, except if the user selects the cancel button 905. FIG. 9B shows the second brew page 900 after the rinsing process is complete. As shown, the rinse button 901″ may change in appearance to indicate that rinsing is complete.

FIG. 9C shows the second brew page 900 after a user may have selected one of the brew size button 902. In the illustrated example, a user may have selected the small option 903′. As shown, the small option 903′ may change in appearance to indicate that brewing is in progress. The other brew size buttons 902 may change in appearance to indicate that additional brewing commands may not be accepted. In the illustrated example, the large option 904″ is darkened to indicate that brewing is already in progress and no additional brewing commands may be accepted. Additionally, the second brew page 900 may display the timer 906 to indicate the amount of time left in the brewing process.

FIG. 9D shows brew detail page 910 which may display details about a brewing process. For example, the brew detail page 910 may display information about an in-progress brew. The brew detail page 910 may include a brewing recipe 911. The brewing recipe 911 may include multiple stints 912. At each stint 912, the application may send commands to the coffee machine 602 to dispense a desired amount of water in a desired way. The recipe 911 may include a target time 914 and/or an elapsed time 915 for each stint 912 to indicate the progress of brewing. The brew detail page 910 may further show a total target time 916, a total elapsed time 917, and/or a total volume 913 for the water that is dispensed. In the illustrated embodiment, the brew detail page 910 may only allow a user to view brewing details and/or may not allow a user to edit the information so as to alter the brew process. Optionally, the brew detail page 910 may include a back button 919 that allows a user to return to the second brew page 900, shown in FIGS. 9, 9A, and 9B.

FIG. 9E shows a brew detail page 920 that is an alternate embodiment of the brew detail page 910 shown in FIG. 9D. The brew detail page 920 may display similar or the same information as the brew detail page 910. In the illustrated example, the brew detail page 920 may be rotated in a landscape orientation. For example, the application may change the display to the brew detail page 920 in FIG. 9E when the device is rotated into a landscape orientation. As shown, the brew detail page 920 may include stint markers 921, 922, 923, and/or 924. The stint markers 921, 922, 923, and/or 924 may display information for each stint and can be positioned according to the target time 914. The displayed information may include the elapsed pour time 915 and/or the amount of water poured for example.

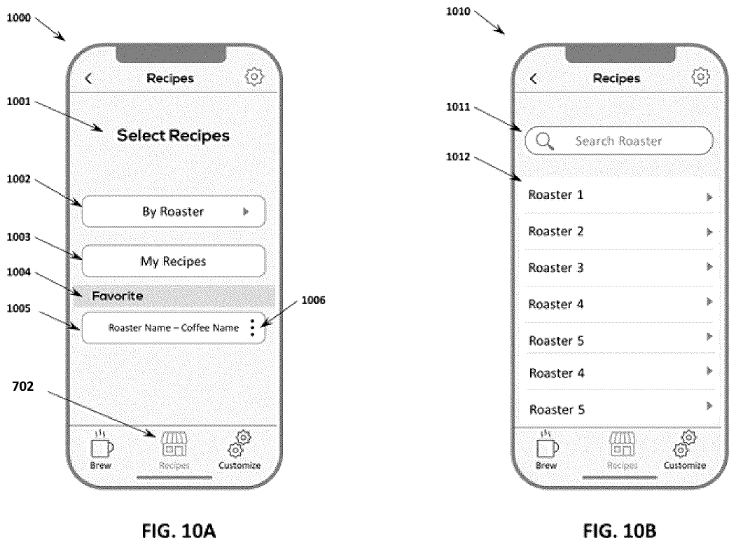

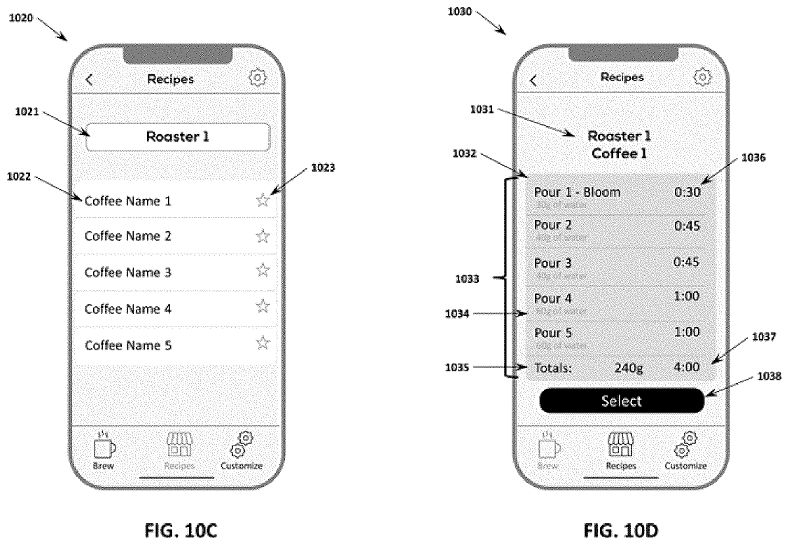

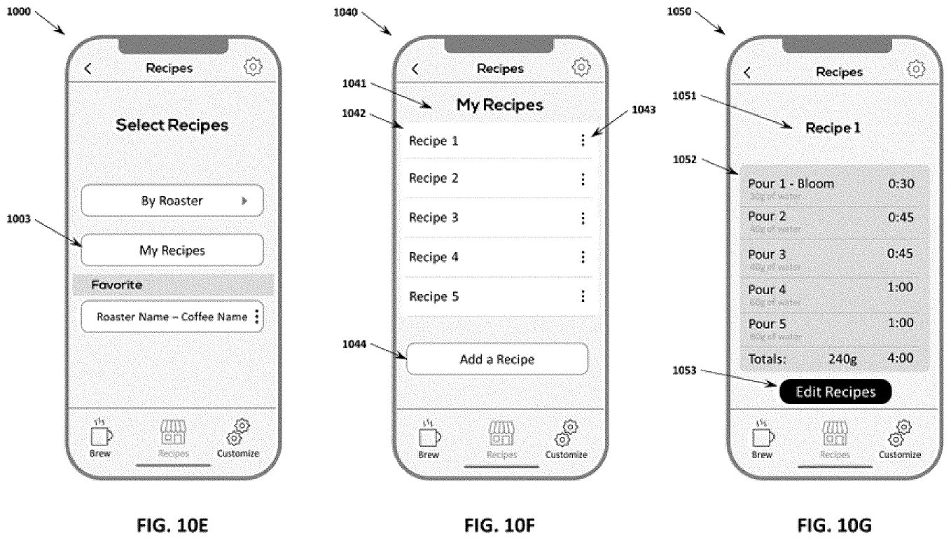

FIGS. 10A and 10E show a recipe page 1000. The application may display the recipe page 1000 when a user selects the recipe mode 702, shown in FIG. 7. The recipe page 1000 may include a title 1001 that indicates the mode of use. The recipe page 1000 may include a roaster option 1002 to allow a user to select a recipe from a specific roasters, and/or a user recipe option 1003 to allow a user to select a recipe that has been saved by the user. The recipe page 1000 may further include a favorite section 1004 that displays favored recipes by the user. The favorite section 1004 may include one or more recipe tiles 1005 that a user may select. When the user selects a recipe tile 1005 from the favorite section 1004, the application may display the brew page 900, shown in FIG. 9, to allow the user to begin the rinsing and/or brewing process according to the selected recipe. Each recipe tile 1005 may further include an edit button 1006. The user may optionally select the edit button 1006 on the recipe tile 1005 to view and/or edit the recipe.

FIG. 10B shows a roaster selection page 1010. When the user selects the roaster option 1002 in FIG. 10A, the application may display the roaster selection page 1010. The roaster selection page 1010 may allow the user to select from recipes provided by specific roasters. As shown, the roaster selection page 1010 may include a search bar 1011 and/or a roaster list 1012. The user may search for a desired roaster using the search bar 1011 and/or may scroll through and select a roaster from the roaster list 1012.

FIG. 10C shows a roaster recipe selection page 1020. The application may display the roaster recipe selection page 1020 when a user selects a roaster from the roaster selection page 1010. The selection page 1020 may include the roaster name 1021 and/or a recipe list 1022 showing recipes from the selected roaster. The recipe list 1022 may include star buttons 1023 on each recipe to allow the user to add the recipe to the favorite section 1004 on the recipe page 1000 in FIG. 10A.

FIG. 10D shows a roaster recipe detail page 1030 that the application may display when the user selects a recipe from the recipe list 1022 shown in FIG. 10C. The roaster recipe detail page 1030 may include a recipe name 1031 and/or recipe information 1032. The recipe information 1032 may include a stints list 1033, a total amount 1035, and/or a total time 1037. The stint list 1033 may include a timing 1036, an amount 1034, and a time 1036 for each stint. The amounts 1034 and 1035 may indicate the amount of water to be dispensed in grams or mL. The detail page 1030 may further include a select button 1038 that allows a user to select the recipe for brewing. When a user selects the select button 1038, the application may display the brew page 900, shown in FIG. 9, to allow the user to begin the rinsing and/or brewing process according to the selected recipe. A user may return to a previous page anytime by selecting the back arrow 1201.

FIG. 10F shows user recipe selection page 1040 that the application may display when the user selects the user recipe option 1003 on the recipe page 1000. The user recipe selection page 1040 may include a title 1041, a recipe list 1042, and/or a new recipe button 1044. The recipe list 1042 may allow a user to select from saved user recipes. Each recipe on the recipe list 1042 may include an edit button 1043 that allows a user to view and/or edit the recipe. The add recipe button 1044 may allow a user to add a recipe to the saved recipe list 1042.

FIG. 10G shows a user recipe detail page 1050 that the application may display when the user selects the edit button 1043 on a recipe on the user recipe selection page 1040. Optionally, the application may display the recipe detail page 1050 when a user selects the edit button 1006 shown in FIG. 10A. The user recipe detail page 1050 may display recipe details 1052 that may include the number of pouring stints, the volume of water to be dispensed, and/or the wait time between pours. A user may edit the recipe by clicking on an edit recipe button 1053.

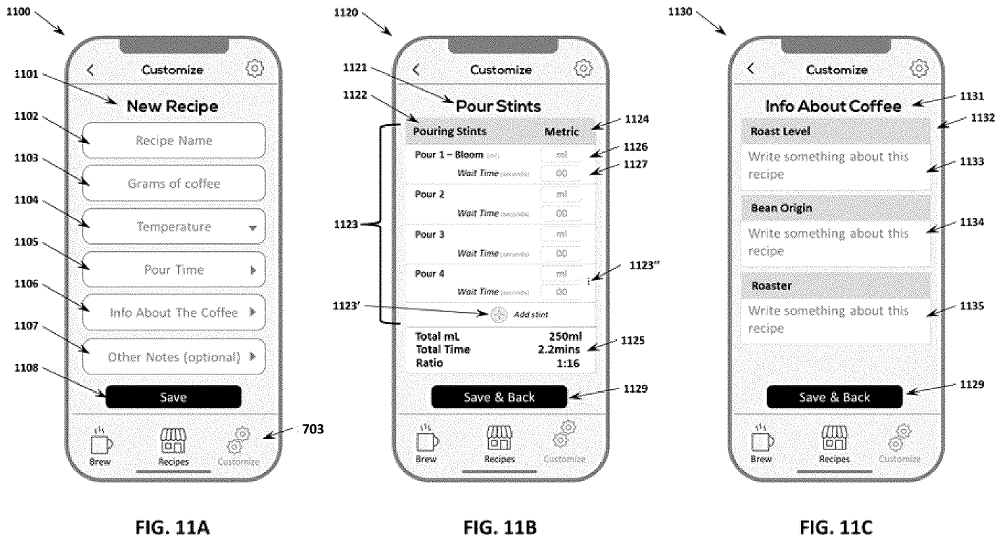

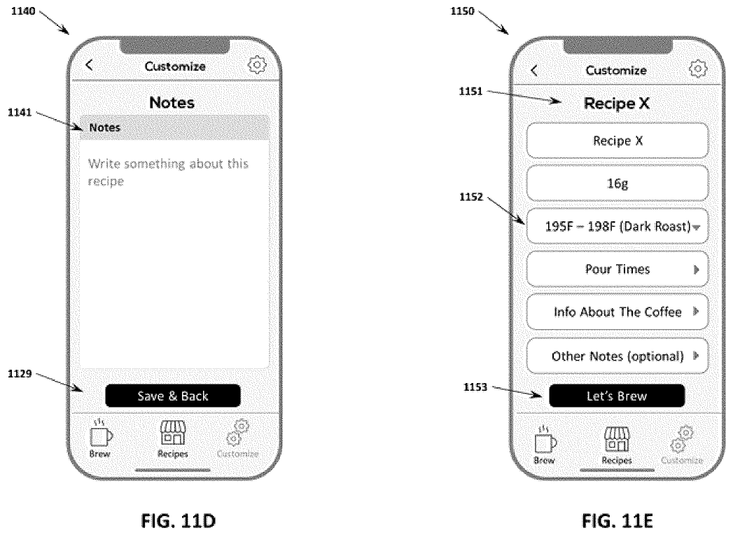

FIG. 11A shows a customization page 1100 that may be displayed when a user selects the customize mode 703 from the main user interface 700. Optionally, the application may display the customization page 1100 when a user selects the edit recipe button 1053 on the recipe detail page 1050 shown in FIG. 10G. The customization page 1100 may allow a user to customize a recipe by choosing a variety of brewing parameters. The customization page 1100 may include a title 1101, a name input 1102, an amount input 1103, a temperature input 1104, a pour time input 1105, an information input 1106, and/or a notes inputs 1107. The name input 102 may allow the user to edit the name of the recipe and/or the title 1101. The amount input 1103 may allow the user to specify the amount of coffee used in the recipe. The temperature input 1104 may allow the user to choose the brew temperature, for example from a drop-down list of temperatures. The pour time input 1105 may allow the user to customize the pour time and/or the amount of pouring stints. The information input 1106 and/or notes input 1107 may allow the user to provide additional information and/or comments about the recipe, and the notes input 1107 may be optional. After a user has filled the required fields, the user may save the recipe by selecting a save button 1108. After a user selects the save button 1108, the recipe may be available to select on the recipe page 1000 and/or user recipe selection page 1040.

FIG. 11B shows a stint selection page 1120 that the application may display when the user selects the pour input 1105 on customization page 1100 shown in FIG. 11A. The stint selection page 1120 may include a title 1121, a stints list 1123, a recipe total 1125, and/or a save button 1129. The stint list 1123 may include details 1122 and/or metrics 1124. The details 1122 may display information such as the number of stints, the amount of water dispensed, and/or the timing. The metrics 1124 may allow a user to enter specific values for the amount of water being dispensed in the stint and/or the amount of time for each stint. As illustrated, the metrics 1124 may include an amount field 1126 to record the amount of water dispensed in the stint and/or a wait time field 1127 to record the amount of time to wait before the next stint. The recipe total 1125 may include total volume of water, total pour and/or wait time, the ratio of coffee to water, and/or other information for the recipe as a whole. In one example, the ratio of coffee to water may be calculated by dividing the grams of coffee entered in the amount input 1103 by the total volume of water in the metrics 1124 of the stints list 1123. The stints list 1123 may allow the user to add and/or remove stints by clicking on the add button 1123′ and/or edit button 1123″. When the user selects the save button 1129, the application may save the input and/or return the user to the customization page 1100.

FIG. 11C shows a recipe information page 1130 that the application may display when a user selects the information input 1106 on the customization page 1100 in FIG. 11A. The recipe information page 1130 may include a title 1131, a roast level section 1132, a bean origin section 1134, a roaster section 1135, one or more input fields 1133, and/or the save button 1129. The roast level section 1132 may allow a user to input information about the roast level of the coffee in the recipe. The bean origin section 1134 similarly may allow a user to input information about the origin of the coffee beans. The roaster section 1135 may allow the user to input information about the roaster of the coffee beans. The input fields 1133 may allow the user to enter the information for each section. After entering the information, the user may select the save button 1129 to save the input and/or return to the customization page 1100.

FIG. 11D shows a notes page 1140 that the application may display when a user selects the notes input 1107 on the customization page 1100 in FIG. 11A. The notes page 1140 may include a notes field 1141 and/or the save button 1129. The notes field 1141 may allow the user to enter general notes about the recipe 1141. After entering the information, the user may select the save button 1129 to save the input and/or return to the customization page 1100.

FIG. 11E shows a completed customization page 1150. When the user has entered information in the required fields of the customization page 1100, shown in FIG. 11A, the application may display the completed customization page 1150. As should be appreciated, the completed customization page 1150 may display one or more fields of entered information as the user enters inputs for one or more fields. As illustrated, the completed customization page 1150 may include the customized title 1151 and/or the customized temperature 1152 for the recipe. After the user has entered all the required information, the user may then select a brew button 1153 to save the recipe and/or allow the user to begin brewing the recipe. In one embodiment, the application may not allow the user to select the brew button 1153 if any of the required information is not entered.

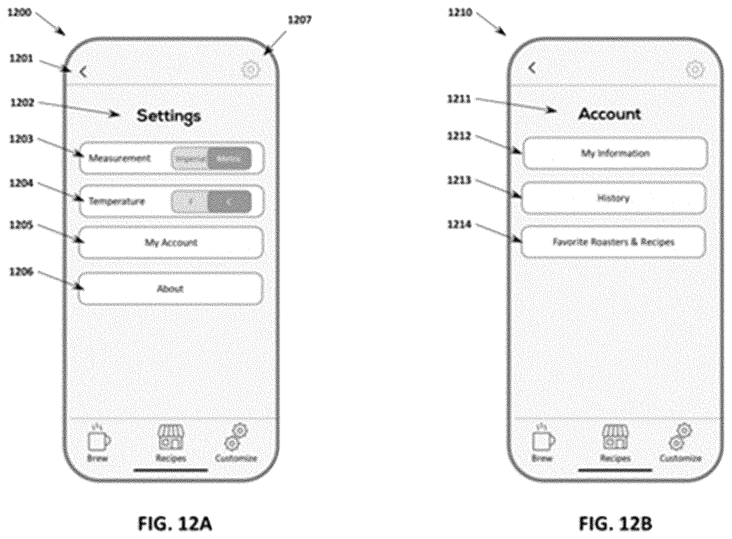

FIG. 12A shows a settings page 1200 that may allow the user to manage various application settings and preferences. The application may display the settings page when the user selects the settings button 1207, also shown in FIG. 7. The settings page 1200 may include a back arrow 1201, a title 1202, a general measurement preference 1203, a temperature unit preference 1204, an account tile 1205, and/or an application information tile 1206. The back arrow 1201 may allow the user to return to a previous screen. The general measurement preference 1203 may allow a user to select between imperial and metric units. Similarly, the temperature unit preference 1204 may allow the user to select between Celsius and Fahrenheit. The account tile 1205 may allow the user to access additional account information, and/or the application information tile 1206 may allow the user to access information about the software version and/or updates of the application.

FIG. 12B shows an account page 1210 that may allow the user to manage account information. The application may display the account page 1210 after a user selects the account button 1205 on the settings page 1200 in FIG. 12A. The account page 1210 may include a title 1211, an information tile 1212, a history tile 1213, and/or a favorites tile 1214. The information tile 1212 may allow the user to access personal information stored on the application. The history tile 1213 may allow the user to view previous activities on the application, such as past recipes brewed. The favorites tile 1214 may allow the user to view and/or edit a favorites list, such as by directing the user to the favorites section 1004 shown in FIG. 10A.

The uses of the terms “a” and “an” and “the” and similar references in the context of describing the invention (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

What is claimed is:

1. An apparatus for brewing coffee comprising:
a nozzle configured to dispense a fluid;
a disk assembly comprising
a first disk defining an opening, wherein the opening is configured to receive the nozzle through said opening, and wherein the opening extends in a radial direction on the first disk, and
a second disk defining a guide opening, wherein the guide opening is configured to receive the nozzle through said guide opening, wherein the guide opening transverses the second disk;
a drive system mechanically linked to the first disk;
wherein the first disk is rotatably coupled to the second disk, wherein the drive system is configured to rotate the first disk relative to the second disk, and wherein the first disk is configured to move the nozzle while rotating; and
wherein the opening on the first disk is configured to allow the nozzle to move in a radial direction, and wherein the guide opening on the second disk is configured to direct the nozzle at least partially in a circumferential direction while the first disk moves the nozzle.

2. The apparatus of claim 1, wherein the guide opening on the second disk is spiral shaped, and wherein the disk assembly is configured to move the nozzle in a spiral-shaped path.

3. The apparatus of claim 1, wherein the disk assembly is configured to limit movement of the nozzle in a longitudinal direction.

4. The apparatus of claim 3, wherein the first disk defines a rail around the opening, wherein the nozzle includes a ring extending in a radial direction around the nozzle, and wherein the rail is configured to receive the ring.

5. The apparatus of claim 1, wherein the first disk and second disk are made of a low-friction material.

6. A system for brewing coffee comprising:
a nozzle configured to dispense a fluid;
a disk assembly configured to support the nozzle, wherein the disk assembly defines a guide opening configured to receive the nozzle, and wherein the guide opening is at least partially spiral shaped;
a drive system mechanically linked to the disk assembly;
a body defining a central opening; and
a receptacle including a dripper;
wherein the body is configured to receive the receptacle in the central opening, and wherein the body is configured to support the disk assembly above the receptacle; and
wherein the drive system is configured to rotate the disk assembly, wherein the disk assembly is configured to move the nozzle along the guide opening, and wherein the nozzle is configured to dispense fluid into the dripper as the nozzle moves in a spiral pattern.

7. The system of claim 6, wherein the disk assembly includes
a first disk defining an opening configured to receive the nozzle, and wherein the opening extends in a radial direction on the first disk;
a second disk defining the guide opening; and
wherein the first disk is rotatably coupled to the second disk, wherein the drive system is configured to rotate the first disk relative to the second disk, and wherein the first disk is configured to move the nozzle along the guide opening.

8. The system of claim 6, further comprising:
a control unit, wherein the control unit is configured to operate one or more components, and wherein the control unit is configured to control speed and direction that the drive system rotates.

9. The system of claim 8, further comprising:
a pump fluidly connected to the nozzle through a hose, wherein the pump is configured to move a fluid through the hose to the nozzle; and
wherein the control unit is configured to control the time and speed at which the pump operates.

10. The system of claim 8, wherein a hose is connected to the nozzle using a swivel fitting.

11. The system of claim 9, wherein the pump is connected to a multi-way valve, wherein, in one arrangement, the multi-way valve is configured to connect the nozzle to the pump, and wherein, in another arrangement, the multi-way valve is configured to connect the pump to another component; and
wherein the control unit is configured to operate the pump and the multi-way valve to move fluid to the nozzle during a specified pour time, and to operate the pump and the multi-way valve to move fluid to another component away from the nozzle after the specified pour time.

12. The system of claim 9, wherein the control unit is configured to determine when the nozzle is at an end of the guide opening.

13. The system of claim 9, further comprising:
a heater configured to heat fluid before the pump moves the fluid to the nozzle; and
a temperature sensor configured to measure a temperature of the fluid; and
wherein the control unit is configured to operate the heater based on the measured temperature of the fluid and to control the temperature to which the heater heats the fluid.

14. The system of claim 8, wherein the control unit is configured to communicatively couple to an external device, and wherein the control unit is configured to operate one or more components based on instructions received from the external device.

15. The system of claim 14, wherein the external device is a mobile device, and the mobile device allows a user to enter instructions through an application installed on the mobile device.

16. The system of claim 14, wherein the external device allows a user to create and store a custom set of commands.

17. The system of claim 6, wherein the central opening extends from a first side of the body to a second side of the body such that when the receptacle is positioned within the central opening, the dripper is visible from the first side and from the second side.

18. A method for brewing coffee comprising the acts of:
rotating a first disk relative to a second disk using a motor wherein said first disk and said second disk support a nozzle for dispensing a fluid;
moving said nozzle using the first disk;
guiding said nozzle along a guide opening using the second disk; and
dispensing a fluid through said nozzle.

19. The method of claim 18, further comprising:
determining the nozzle is at an end of the guide opening; and
moving nozzle in an opposite direction using the first disk.

20. The method of claim 18 wherein the guide opening is spiral-shaped.
